(19) United States
(12) Patent Application Publication
(10) Pub. No.: US 2016/0020914 A1
(43) Pub. Date: Jan. 21, 2016

(54) METHOD, APPARATUS, AND SYSTEM FOR PROVIDING BILLING ENTITY INFORMATION FOR A WEB SESSION

(71) Applicant: Verizon Patent and Licensing Inc., Arlington, VA (US)

(72) Inventor: Allen MOORE, Florence, AL (US)

(21) Appl. No.: 14/332,030

(22) Filed: Jul. 15, 2014

(51) Int. Cl. H04L 12/14; G06F 17/30

(52) U.S. Cl. CPC H04L 12/1428; G06F 17/30867; H04L 12/1432

(57) ABSTRACT

A method for rerouting and/or suspending data usage charges applicable to a user includes receiving a request from a device to initiate a web session, wherein the request specifies a web address, initiating a query for a billing entity associated with the web address, the web session, or a combination thereof, and transmitting identification information of the billing entity to a service provider associated with the device. The method involves managing the data usage charges of a user by rerouting the data usage charges to the host entity or the broker entity. The method further involves suspending the data usage charges of the user and not rerouting the data usage charges to any entity.

### BACKGROUND INFORMATION

The convenience and usability of online services has led to rapid growth of the online services market. Online service providers are increasingly providing more and more functionalities and convenience to consumers. The online service providers may provide services such as facilitating e-commerce, bill payments, social networking, news, and resources for research.

Generally, a user accesses the online services using network services provided by an Internet Service Provider (ISP). The ISP may connect the user to an online service or website through its network. Typically, online or network services are chargeable to the user, depending on a data plan subscribed by the user with the ISP. This arrangement discourages many users from accessing the online services due to the associated cost of services.

Further, there has been tremendous growth in mobile device access to the online services. Usage of the mobile devices provides for anytime, anywhere access to the online services. However, current arrangements via the ISP may lead to situations, in which a user might feel handicapped if he or she runs out of available quota of data usage as per a subscription plan, and cannot even access emergency online services.

Based on the foregoing, there is a need for an approach to manage access to the online services in an improved way.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of managing data usages charges of a user, according to one embodiment;

FIG. 2 is a diagram of a charging platform capable of managing data usage charges of a user, according to one embodiment;

FIG. 3 is a flowchart of a process for identifying a billing entity, according to one embodiment;

FIG. 4 is a flowchart of a process for managing data usage charges of a user, according to one embodiment;

FIG. 5 is a flowchart of a process for determining subscription status information for a billing entity, according to one embodiment;

FIG. 6 is a sequence diagram for managing data usage charges of a user, according to one embodiment;

FIG. 7 is a diagram of a computer system that can be used to implement various exemplary embodiments; and

FIG. 8 is a diagram of a chip set that can be used to implement various exemplary embodiments.

### DESCRIPTION OF THE PREFERRED EMBODIMENT

An apparatus, a method, and software for managing data usage charges of a user for access to online services are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

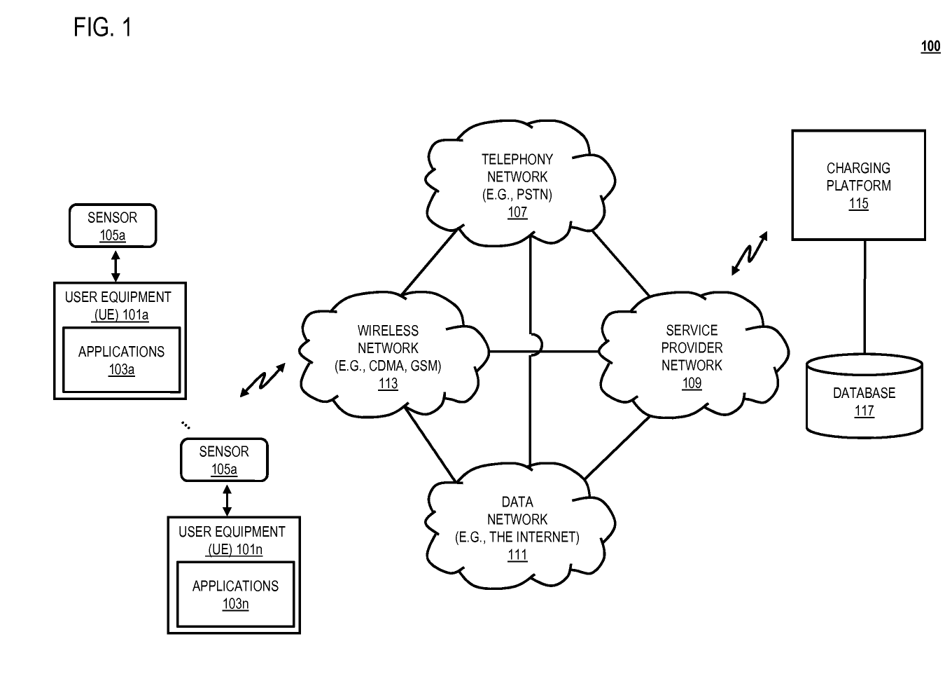

FIG. 1 is a diagram of a system 100 for managing data usage charges of a user, according to one embodiment. In one embodiment, one or more user equipment 101a-101n, hereinafter referred to as user equipment 101, may communicate with a host application associated having a web address for accessing online services via a service provider network 109. The host application may be associated with a web address and may provide online services such as facilitating e-commerce, bill payments, social networking, news, research, and the like.

As used herein, the term ‘user’ may refer to a natural person, a legal person, an organization, a company, a government organization, a group of the foregoing or an automatic machine, device or apparatus capable of executing functions for which the data usage charges may be applicable to it.

The user equipment 101 may include, but is not limited to, a mobile phone device, a Personal Digital Assistant (PDA), a tablet, a smart phone device, a laptop, a palm top, a Personal Computer (PC), an e-reader, or a server. The user equipment 101 may use sensors 105a-105n, hereinafter referred to as sensor 105, for communicating with other devices over one or more networks. In one embodiment, the user equipment 101 may be able to use, via the sensor 105, Near Field Communications (NFCs), Bluetooth, Wi-Fi, Holographic Laser Projection with Infrared or Ultrasound return, and/or Near Sound Data Transfer (NSDT), to communicate with another device in any manner such as placement near an object, a swipe, or a tap. The user equipment 101 may further include applications 103 for facilitating client side communication in accessing the online services.

The one or more networks may include a telephony network 107, a data network 111, and/or a wireless network 113 which may be interconnected with a service provider network 109. The one or more networks may be any suitable wire line and/or wireless network, and be managed by one or more service providers. For example, telephony network 107 may include a circuit-switched network, such as the Public Switched Telephone Network (PSTN), an Integrated Services Digital Network (ISDN), a Private Branch Exchange (PBX), or other like network. The wireless network 113 may employ various technologies including, for example, Code Division Multiple Access (CDMA), Enhanced Data Rates For Global Evolution (EDGE), General Packet Radio Service (GPRS), Mobile Ad Hoc Network (MANET), Global System For Mobile Communications (GSM), Internet Protocol Multimedia Subsystem (IMS), Universal Mobile Telecommunications System (UMTS), etc., as well as any other suitable wireless medium, e.g., Microwave Access (WiMAX), Wireless Fidelity (Wi-Fi), satellite, and the like. Meanwhile, data network 111 may be any Local Area Network (LAN), metropolitan Area Network (MAN), Wide Area Network (WAN), the Internet, or any other suitable packet-switched network, such as a commercially owned, proprietary packet-switched network, such as a proprietary cable or fiber-optic network.

Although depicted as separate entities, the one or more networks 107-113 may be completely or partially contained within one another, or may embody one or more of the aforementioned infrastructures. For instance, the service provider network 109 may embody circuit-switched and/or packet-switched networks that include facilities to provide for transport of circuit-switched and/or packet-based communications. It is further contemplated that the one or more networks 107-113 may include components and facilities to provide for signaling and/or bearer communications between the various components or facilities of system 100. In this manner, the one or more networks 107-113 may embody or include portions of a signaling system 7 (SS7) network, or other suitable infrastructure to support control and signaling functions.

A charging platform 115 communicatively coupled to the service provider network 109 and a database 117 may manage the data usage charges of the user associated with the user equipment 101. In one embodiment, the charging platform 115 may utilize data and/or information stored in the database 117 for managing the data usage charge of the user.

In one embodiment, the database 117 may store user information, host information, broker information and service provider network information. The user information may include profile information such as a name, an address, a phone number associated with the user, and the like. The user information may further include authentication information such as user identification (ID) and a password for authenticating the user. The user information may also include user subscription information such as a subscription plan and validity period of the subscription plan.

In one embodiment, the database 117 may be an external database coupled to the charging platform 115 at same geographical site as the charging platform 115. In another embodiment, the database 117 may be an internal part of the charging platform 115. In yet another embodiment, the database 117 may be located on a geographically remote site and communicatively coupled to the charging platform 115. In another embodiment, the database 117 may be a collection of database distributed over multiple computing devices. The database 117 may be any proprietary or non-proprietary database capable of storing, retrieval, and persisting of the information.

In one scenario, the user may utilize the user equipment 101 to establish a communication session (for example, a web session) with the host application. The web session may be established by utilizing services provided by the ISP. In order to initiate the web session, the user equipment 101 may send a session request to a web address of the host application. The web address may be, but is not limited to, a Uniform Resource Locator (URL), a Uniform Resource Identifier (URI), or any other identifiers, that may uniquely identify the host application and its associated objects over the network 107-113, such as the Internet. In an implementation, the session request may be sent via the ISP. The session request may be resolved to the intended web address by a Domain Name System (DNS). In one embodiment, the ISP and DNS are part of service provider network 109.

Further, a secure channel may be established between the ISP and the host application to exchange data securely and confidentially. The secure channel establishment may be based on an encryption key exchange between the ISP and the host application. In one scenario, the web session may be enabled between the user equipment 101 and the host application based on the encryption key exchange. Further, an end-to-end secure channel may be established between the user equipment 101 and the host application. In one embodiment, the secure channel may be, but not limited to, a Transport Layer Security (TLS) and a Secure Sockets Layer (SSL). The user equipment 101 may access data, applications, or other information associated with the host application from the database 117 during the web session.

In one embodiment, a security element (not shown) may be used to secure communication between one or more network nodes. The security element may be implemented as hardware, software or a combination thereof. In one implementation, the security element may be an Internet firewall. The security element may be implemented to secure the communication over the one or more networks from security threats, such as malware, eavesdropping or a virus.

In one embodiment, the system 100 manages the data usage charges of the user by utilizing the charging platform 115. The system 100 may reroute data usage charges of the user to the host entity or the broker entity. In one embodiment, the system 100 may suspend the data usage charges of the user and may not reroute the data usage charges to any entity.

Thus, the present invention provides for suspension or rerouting of the data usage charges of the user. Such an arrangement may be mutually beneficial for the host entity, the user, and the broker entity.

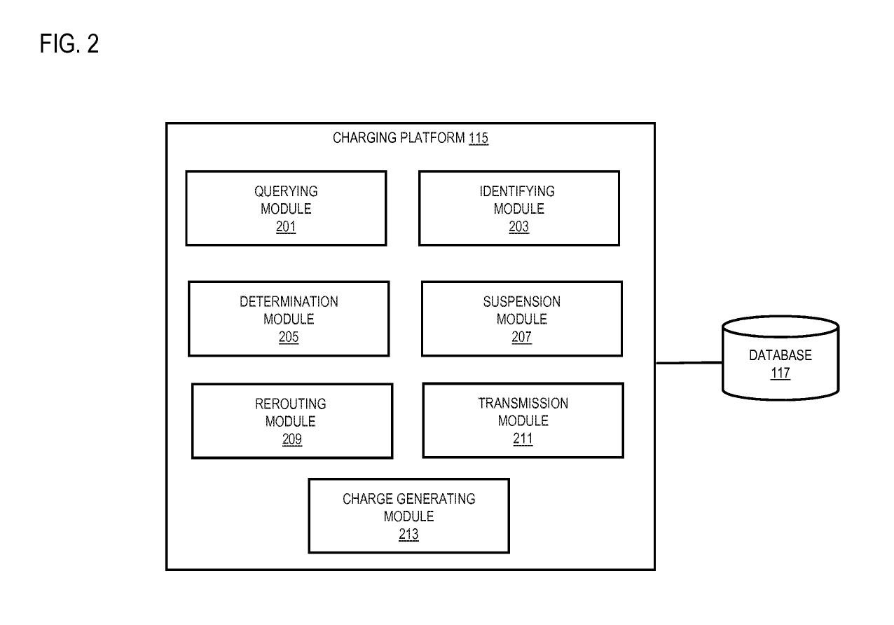

FIG. 2 is a diagram of components of the charging platform 115 for managing data usage charges of a user, according to one embodiment. The charging platform 115 may include one or modules for carrying out various functions for managing the data usage charges. The one or more modules may be implemented as hardware, software, or a combination thereof. In one embodiment, the charging platform 115 may include a querying module 201, an identifying module 203, a determination module 205, a suspension module 207, a rerouting module 209, a transmission module 211, and a charge generating module 213.

The querying module 201 may initiate a query for a billing entity when the user equipment 101 establishes the web session with the host application. In one embodiment, the query for a billing entity may be associated with a web address, a web session, or a combination thereof. The query for the billing entity may be directed to the database 117. The database 117 may store information relating to billing entities, users, user equipment 101, toll free URLs, web providers, and/or ISPs.

The identifying module 203 may retrieve identification information of the billing entity from the database 117. In one implementation, the identification information may include, but is not limited to, a Media Access Control (MAC) address. The identifying module 203 may further identify packet data exchanged between the user equipment 101 and the host application. For example, when a user requests to initiate a web session with a host application then the number of data packets transmitted from the host application to the user equipment 101 is identified, captured and/or stored. In one embodiment, the packet data exchanged between the user equipment 101 and the host application may be identified during the web session based on the web address, the web session, or a combination thereof. The determination module 205 may then determine whether the data usage charges of the user are to be suspended or rerouted based on the subscriber or host identification information and the identified packet data. In one embodiment, if the user is a subscriber of the ISP then the data usage charges may be suspended, otherwise the data usage charges may be rerouted to the billing entity. Although various embodiments are described with respect to packet data, the invention is not limited to packet data. It is contemplated that the embodiments described herein are applicable to any services that can be modeled according the example processes described herein.

If the data usage charges are to be suspended, then the suspension module 207 is activated. The suspension module 207 may suspend data usages charges, an invoice, or a combination thereof for the packet data utilized by the user. The data usage charges may be suspended based on the identification information, billing entity, or a combination thereof. In one embodiment, the data usage charge may be suspended for a portion of the web session between the user equipment 101 and the host application. In another embodiment, the data usage charges may be suspended for whole of the web session. In yet another embodiment, an amount of the data usage charges to be suspended is based on the packet data exchanged between the user equipment 101 and the host application. The suspension module 207 may use any other algorithm, technique, or method for determining the amount of data usage charges to be suspended.

If the data usage charges are to be rerouted, then the rerouting module 209 is activated. The rerouting module 209 may reroute the data usage charges or an invoice of the data used by the user. In one embodiment, the data usage charges may be rerouted based on the identification information of the billing entity. In another embodiment, the data usage charges may be rerouted for a portion of the web session between the user equipment 101 and the host application. In one embodiment, the data usage charges may be rerouted for whole of the web session. Also, an amount of the data usage charges to be rerouted may be based on the packet data exchanged between the user equipment 101 and the host application, in one embodiment. The rerouting module 209 may use any other algorithm, technique, or method for determining the amount of data usage charges to be rerouted.

In the above rerouting arrangement, the data usage charges may be borne by the host entity which owns or manages the host application. The host entity may provide for rerouting of the data usage charges from the user to itself based on commercial, business, and/or financial motives. In another embodiment, the data usage charges may borne by the broker entity which may be interested in such an arrangement with the ISP and/or the user. The broker entity may have rerouting arrangement for the data usage charges with a plurality of host entities, a plurality of ISPs, a plurality of users, and/or a plurality of other broker entities.

The transmission module 211 may create a database or a billing domain system query for storing and/or updating the database 117 with association information between the identified billing entity and the web address of the web session. In one scenario, a billing domain system may provide information to the charging platform 115 to cause a suspension of data transport billing associated with a session from the data plan and/or payment plan of a user, and charge the data transport billing associated with a session to a service provider. The database query may be sent to the database 117 for further processing. The transmission module 211 may also transmit billing parameter information with a domain name system packet that may be associated with the billing entity, the web address, the web session, or a combination thereof.

The charge generating module 213 may generate data usage charges or invoice that are to be billed to the user and data usage charges that are to be billed to the host entity. The determination module 205 may determine subscription status information of the user equipment 101, a user of the user equipment 101, and the host entity. In one embodiment, the subscription status information may be determined based on the subscription information stored in the database 117. In one embodiment, the subscription status information may include a data plan subscribed by the user or the host entity. Examples of the data plan may include, but not limited to, a fixed payment per session, or over a predefined duration.

The transmission module 211 transmits the subscription status information and amounts to be billed to the ISP for further processing. The ISP may generate a bill or invoice for the user based on the subscription status information of the user and data usage charges generated by the charge generating module 213. Similarly, the ISP may generate a bill or invoice for the host entity based on the subscription status information of the host entity and data usage charges generated by the charge generating module 213.

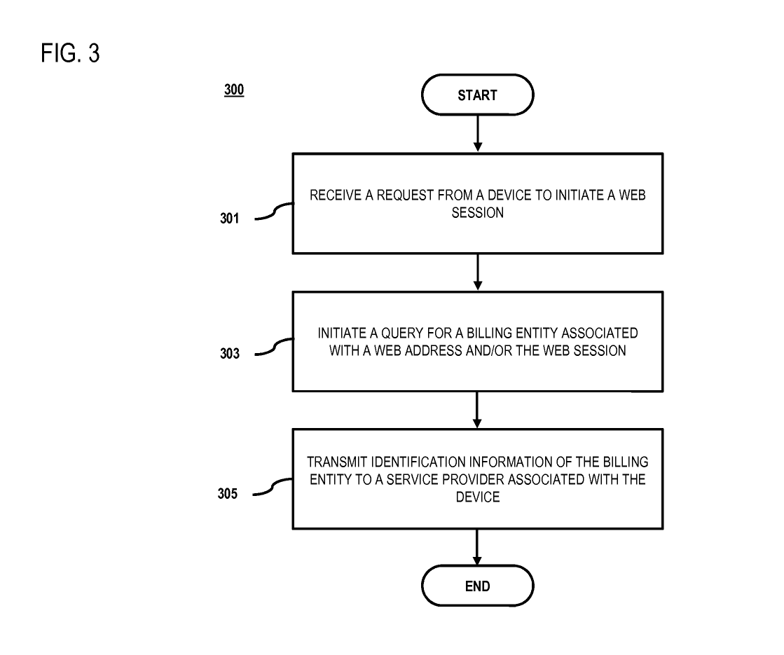

FIG. 3 is a flowchart of a process 300 for identifying a billing entity, according to one embodiment. It is noted that the steps of the process 300 may be performed in any suitable order, as well as combined or separated in any suitable manner.

At step 301, a request from a device, for example, the user equipment 101 is received at a host application to initiate a web session. The web session may be established between the user equipment 101 and the host application by utilizing network services of an ISP. In one embodiment, a secure channel may be established between the ISP and the host application to exchange data securely and confidentially and therefore a secure channel is established between the user equipment 101 and the host application. The secure channel establishment may be based on an encryption key exchange between the entities participating in the web session. In one embodiment, the secure channel may be, but not limited to, a Transport Layer Security (TLS) and a Secure Sockets Layer (SSL). The web session may be enabled between the user equipment 101 and the host application based on the encryption key exchange.

At step 303, a query to identify a billing entity for the web session may be initiated. In one embodiment, the billing entity may be identified by the identifying module 203 based on the information stored in the database 117. Further, the query may be directed to the database 117 to retrieve identification information of the billing entity. In one scenario, when the billing entity is the subscriber, the identification information may include a Media Access Control (MAC) address and/or International Mobile Equipment Identity (IMEI) number associated with the subscriber. In another embodiment, when the billing entity is the host application, the identification information may include a web address of the host application.

Next, at step 305, the identification information of the billing entity is transmitted to a service provider. The service provider may then update the database 117 with the identification information of the billing entity. In one embodiment, the identification information of the billing entity is transmitted to the ISP for further processing.

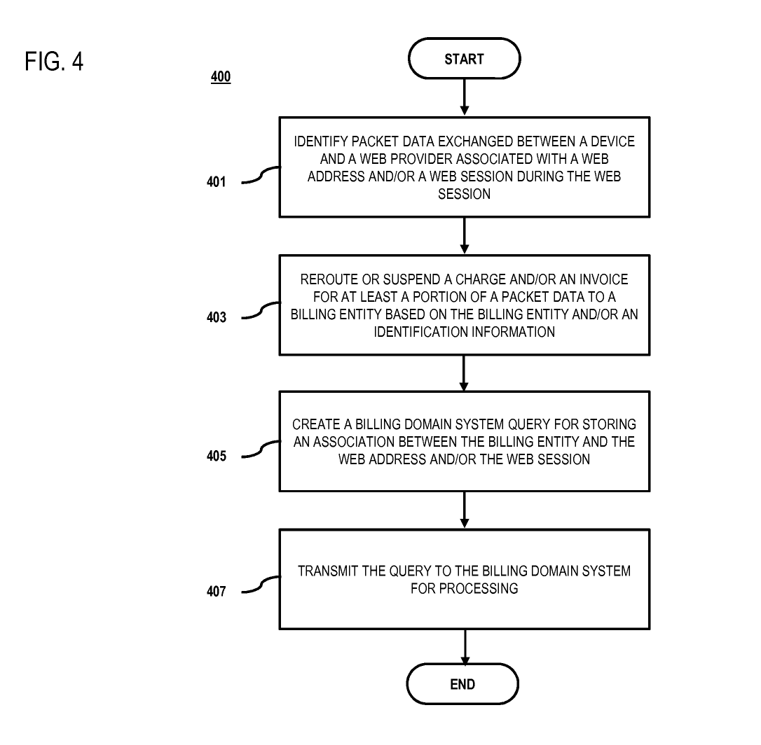

FIG. 4 is a flowchart of a process 400 for managing data usage charges of a user, according to one embodiment. At step 401, subsequent to the web session establishment between the user equipment 101 and the host application, packet data exchanged between the user equipment 101 and the host application during the web session is identified by the identifying module 203.

At step 403, data usage charges or an invoice for data usage during the web session is generated based in the identification information and the packet data exchanged between the user equipment 101 and the host application. In one embodiment, the data usage charges or the invoice may be suspended or rerouted based on the identification information of the billing entity. In one embodiment, the data usage charges are suspended or rerouted only for a portion of the web session. In another embodiment, the data usage charge may be suspended or rerouted for whole of the web session.

The data usage charges may be rerouted to the host entity which owns or manages the host application. The host entity may provide for such rerouting of the data usage charges from the user to itself based on commercial, business, and/or financial motives. In another embodiment, the data usage charges may be rerouted to the broker entity. The data usage charges of the user may be borne by the broker entity which is interested in such an arrangement with the ISP and/or the user.

Thereafter, at step 405, the transmission module 211 may create a database query for storing and/or updating the database 117 with information associated with the identified billing entity and the web address. At step 407, the database query may be transmitted to the database 117 by the transmission module 211 for storing and/or updating the database 117 with information associated with the identified billing entity and the web address.

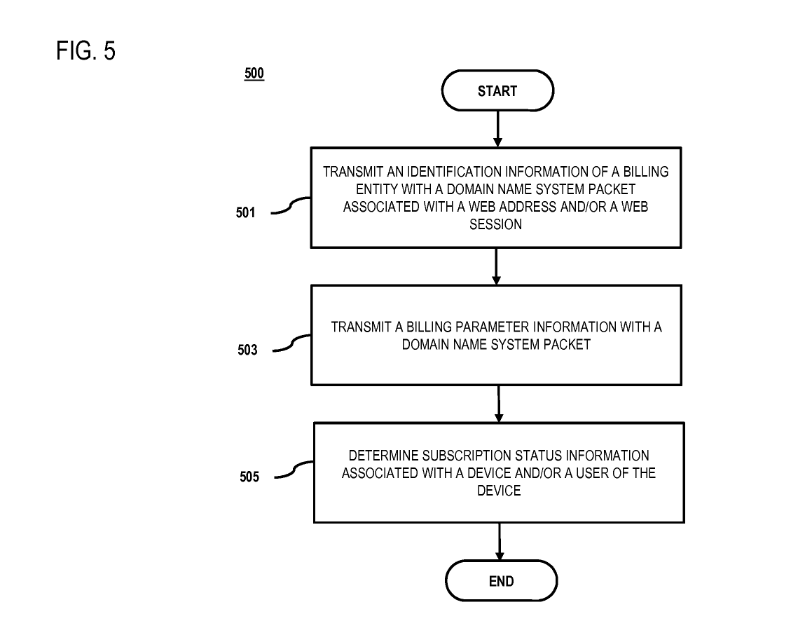

FIG. 5 is a flowchart of a process 500 for determining subscription status information of a billing entity, according to one embodiment.

At step 501, identification information of a billing entity is transmitted by the transmission module 211 to the database 117. In one embodiment, the identification information is transmitted with a Domain Name System (DNS) packet associated with a web session or a web address.

At step 503, a billing parameter is transmitted by the transmission module 211 to the database 117. In one embodiment, the billing parameter is transmitted along with the DNS packet associated with the web session between the user equipment 101 and the host application. In one embodiment, the billing parameter may be subscription information of the billing entity. In one embodiment, the subscription information includes a data plan subscribed by the user or the host entity. Examples of the data plan include, but not limited to, fixed payment per session, or over a predefined duration.

At step 505, subscription status associated with the billing entity is determined by the determination module 205 based on the billing parameter. If the subscription status is an active status, the transmission module 211 transmits the subscription status information and amount to be billed to an ISP for further processing. The ISP may generate a bill or invoice for the user based on subscription status information of the user and data usages charges generated by the charge generating module 213. Similarly, the ISP may generate a bill or invoice for the host entity based on subscription status information of the host entity and data usages charges generated by the charge generating module 213.

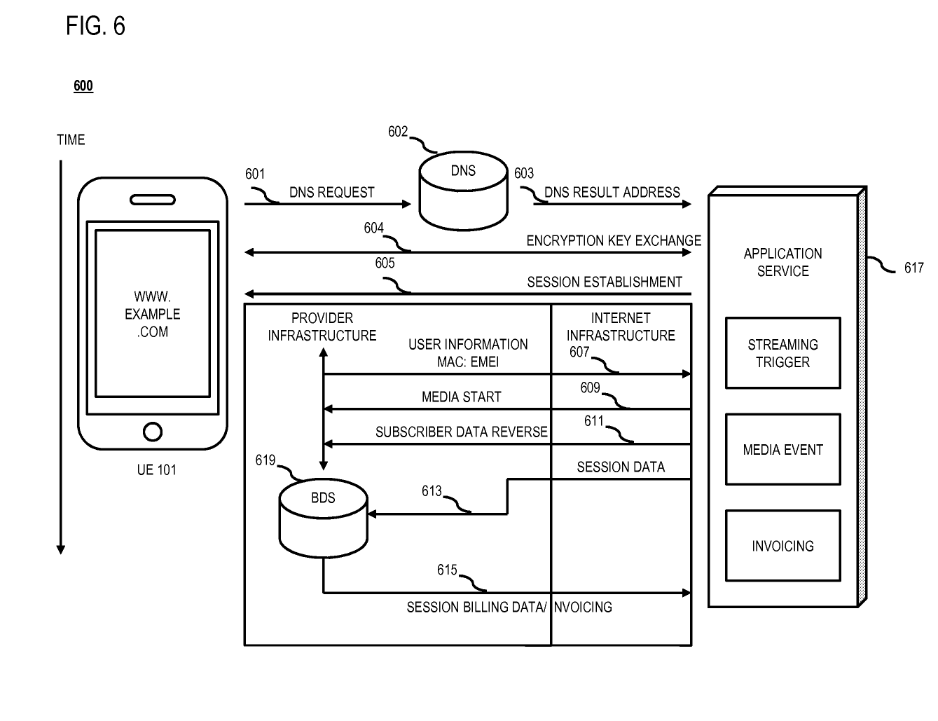

FIG. 6 is a sequence diagram 600 for managing data usage charges of a user, according to one embodiment. This figure is explained with the help of an illustrative URL www.example.com, however, a person skilled in the art would appreciate that the present invention may be practiced with any URL.

The user equipment 101 may send a Domain Name System (DNS) request 601 to a Domain Name System (DNS) 602. The DNS 602 may resolve the DNS request 601 to generate a DNS result address 603. The DNS result address 603 may indicate an application service 617. The application service 617 may be associated with a website, for example, www.example.com. Thereafter, the application service 617 and the user equipment 101 may perform an encryption key exchange 604. The application service 617 may establish a web session 605 with the user equipment 101 in response to the request from the user equipment 101 and based on the encryption key exchange 604. In one embodiment, the application service 617 may include a streaming trigger, a media event, and invoicing functions for carrying out its functions. In one implementation, the streaming trigger may be used to initiate the web session between the user equipment 101 and the application service 617. Further, the media event may control the transmission of packet data, for example, start, stop, pause, etc. exchanged between the user equipment 101 and the application service 617. The invoicing may be utilized to generate data usage charges, an invoice, or a combination thereof for the web session.

After the session establishment, user information 607 associated with the user equipment 101 may be provided to the application service 617. In one embodiment, the user information 607 may be retrieved from a Billing Domain System (BDS) 619 and is then provided to the application service 617. The user information 607 may include a Media Access Control (MAC) address, an International Mobile Equipment Identity (IMEI) number, and the like that is associated with the user equipment 101. The BDS 619 may store information relating to billing entities, users, user equipment 101, and toll free URLs, web providers, and/or ISPs. In one embodiment, the BDS 619 may be included in the database 117. In another embodiment, the BDS 619 is separate from the database 117 and communicatively coupled to the database 117.

After the receipt of the user information 607, the application service 617 may execute media start 609 functionality based on the user information 607. The media start 609 may include exchange of electronic data such as documents, images, audio, and video between the user equipment 101 and the application service 617.

A subscriber data reverse 611 functionality may be executed by the charging platform 115 based on the user information 607 and information stored in the BDS 619. Based on the execution of the subscriber data reverse 611, a session data 613 associated with the web session may be received at the BDS 619. Further, the BDS 619 may generate billing data or an invoice 615 based on the session data 613. The billing data or the invoice 615 may be transmitted by the BDS 619 to the ISP for further processing.

The ISP may reroute or suspend data usage charges of the user based on the billing data or the invoice 615. The data usage charges may be borne by the host entity which owns or manages the host application. The host entity may provide for such rerouting of the data usage charges from the user to itself based on commercial, business, and/or financial motives. In another embodiment, the data usage charges may be borne by the broker entity which is interested in such an arrangement with the ISP and/or the user. The broker entity may have data usage charges suspension or rerouting arrangement with a plurality of host entities, a plurality of ISPs, a plurality of users, and/or a plurality of other broker entities.

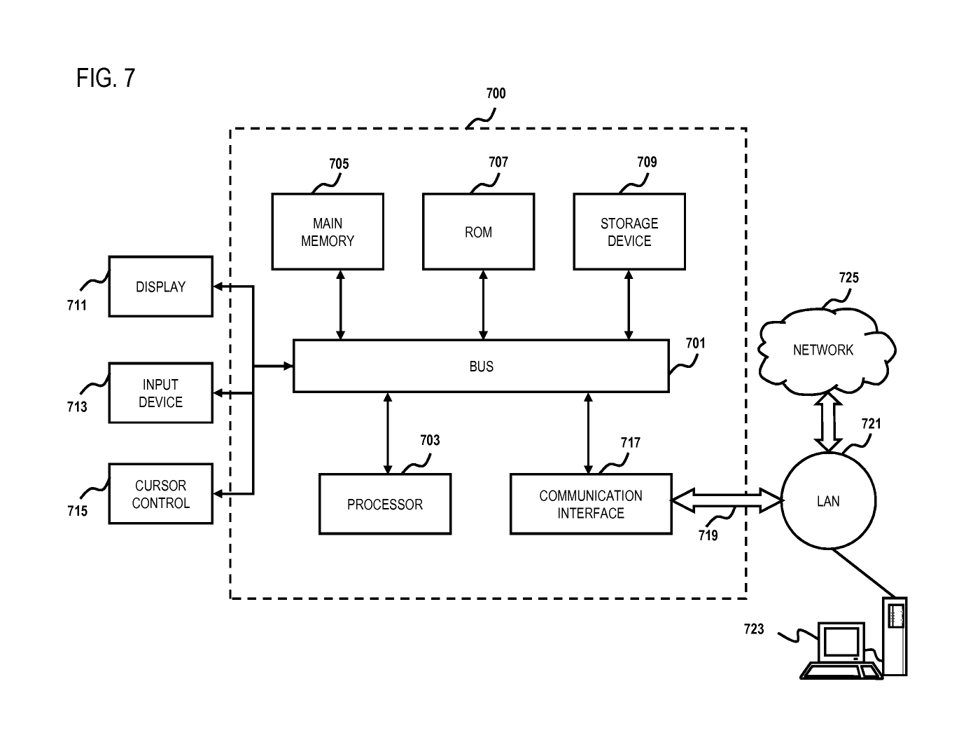

FIG. 7 illustrates computing hardware (e.g., computer system) upon which an embodiment according to the invention can be implemented. A computer system 700 includes a bus 701 or other communication mechanism for communicating information and a processor 703 coupled to the bus 701 for processing information. The computer system 700 also includes main memory 705, such as random access memory (RAM) or other dynamic storage device, coupled to the bus 701 for storing information and instructions to be executed by the processor 703. Main memory 705 can also be used for storing temporary variables or other intermediate information during execution of instructions by the processor 703.

The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), a liquid crystal display (LCD), an active matrix display, or a plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an embodiment of the invention, the processes described herein are performed by the computer system 700, in response to the processor 703 executing an arrangement of instructions contained in the main memory 705. The instructions can be read into the main memory 705 from another computer-readable medium, such as the storage device 709. Execution of the arrangement of instructions contained in the main memory 705 causes the processor 703 to perform the process steps described herein. One or more processors in a multi-processing arrangement may also be employed to execute the instructions contained in the main memory 705. In alternative embodiments, a hard-wired circuitry may be used in place of or in combination with software instructions to implement the embodiments of the invention. Thus, embodiments of the invention are not limited to any specific combination of hardware circuitry and software.

The computer system 700 also includes a communication interface 717 coupled to the bus 701. The communication interface 717 provides a two-way data communication coupling to a network link 719 connected to a local area network (LAN) 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Mode (ATM) network) to provide a data communication connection to the LAN 721. In one embodiment, the computer system 700 may also be implemented in a peer-to-peer approach.

Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through the LAN 721 to a host computer 723, which has connectivity to a network 725 (e.g. a wide area network (WAN) or the global packet data communication network now commonly referred to as the “Internet”) or to data equipment operated by a service provider. The LAN 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network 725, the LAN 721, the network link 719, and/or the communication interface 717. In the Internet example, a server (not shown) might transmit requested code belonging to an application program for implementing an embodiment of the invention through the network 725, the LAN 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703. Such a medium may take many forms, including but not limited to non-volatile media, volatile media, and transmission media. Non-volatile media include, for example, optical or magnetic disks, such as the storage device 709. Volatile media include dynamic memory, such as the main memory 705. Transmission media may include a coaxial cable, a copper wire and/or a fiber optics channel, including the wires that comprise the bus 701. The transmission media can also take the form of acoustic, optical, or electromagnetic waves, such as those generated during radio frequency (RF) and infrared (IR) data communications.

Common forms of computer-readable media include, for example, a floppy disk, a flexible disk, a hard disk, a magnetic tape, a compact disc read-only memory (CD-ROM), a compact disc-rewritable (CD-RW), a digital versatile disc (DVD), a punch card, a paper tape, an optical mark sheet, a random access memory (RAM), a read only memory (ROM), a programmable ROM (PROM), an erasable PROM (EPROM), a FLASH-EPROM, any other magnetic, optical, or physical medium with patterns of holes or other optically recognizable indicia, a memory chip, a cartridge, a carrier wave, or any other medium from which a computer can read. In one embodiment of the present invention, the computer-readable medium includes non-transitory computer-readable medium. In another embodiment of the present invention, the computer-readable medium includes transitory computer readable-medium.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA), a mobile phone, a smart phone or a laptop. An infrared detector on the portable computing device receives the information and instructions borne by the infrared signal and places the data on a bus. The bus conveys the data to a main memory, from which a processor retrieves and executes the instructions. The instructions received by the main memory can optionally be stored on a storage device either before or after execution by the processor.

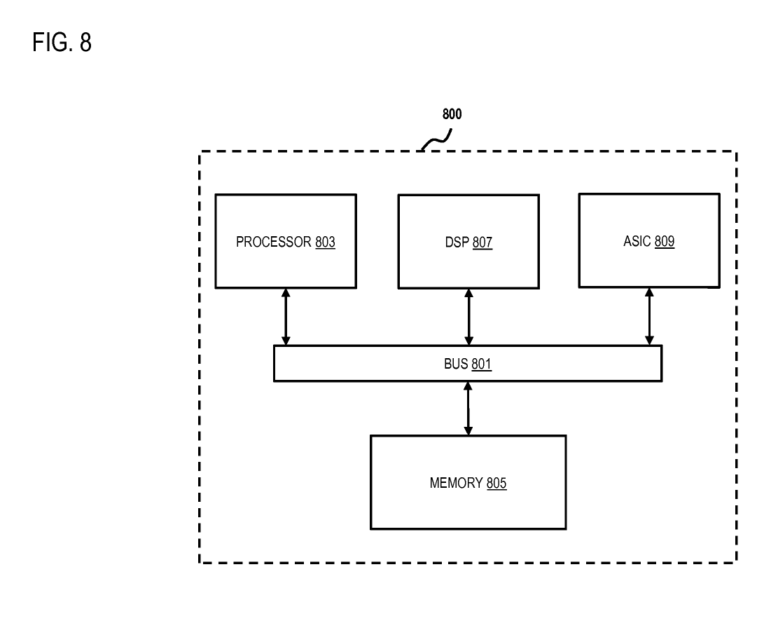

FIG. 8 illustrates a chip set 800 upon which an embodiment of the invention may be implemented. The chip set 800 is programmed to generate billing information from a device that includes, for instance, the processor 703 and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. The chip set 800, or a portion thereof, constitutes a means for performing one or more steps of FIGS. 4-6.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading.

The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to perform specialized functions not easily performed by a general purpose processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to control a set-top box based on device events. The memory 805 also stores data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving a request from a device to initiate a web session, wherein the request specifies a web address;
initiating a query for a billing entity associated with the web address, the web session, or a combination thereof; and
transmitting identification information of the billing entity to a service provider associated with the device.

2. A method of claim 1, further comprising:
identifying packet data exchanged between the device and a web provider associated with the web address, the web session, or a combination thereof during the web session; and
rerouting or suspending a charge, an invoice, or a combination thereof for at least a portion of the packet data to the billing entity based on the billing entity, the identification information, or a combination thereof.

3. A method of claim 1, further comprising:
creating a billing domain system query for storing an association between the billing entity and the web address, the web session, or a combination thereof; and
transmitting the query to a billing domain system for processing.

4. A method of claim 1, further comprising:
transmitting the identification information of the billing entity with a domain name system packet associated with the web address, the web session, or a combination thereof.

5. A method of claim 4, wherein the query includes querying for billing parameter information associated with the billing entity, the web address, the web session, or a combination thereof, the method further comprising:
transmitting the billing parameter information with the domain name system packet.

6. A method of claim 1, further comprising:
determining subscription status information associated with the device, a user of the device, or a combination thereof,
wherein the initiating of the query for the billing entity, the transmitting of the identification information to the service provider, or a combination thereof is based on the subscription status information.

7. A method of claim 1, wherein the identification information includes a media access control (MAC) address.

8. An apparatus comprising a processor configured to:
receive a request from a device to initiate a web session, wherein the request specifies a web address;
initiate a query for a billing entity associated with the web address, the web session, or a combination thereof; and
transmit identification information of the billing entity to a service provider associated with the device.

9. An apparatus of claim 8, further comprising:
identify packet data exchanged between the device and a web provider associated with web address, the web session, or a combination thereof during the web session; and
reroute or suspend a charge, an invoice, or a combination thereof for at least a portion of the packet data to the billing entity based on the billing entity, the identification information, or a combination thereof.

10. An apparatus of claim 8, further comprising:
create a billing domain system query for storing an association between the billing entity and the web address, the web session, or a combination thereof; and
transmit the query to a billing domain system for processing.

11. An apparatus of claim 8, further comprising:
transmit the identification information of the billing entity with a domain name system packet associated with the web address, the web session, or a combination thereof.

12. An apparatus of claim 11, wherein the query includes querying for billing parameter information associated with the billing entity, the web address, the web session, or a combination thereof, the apparatus further comprising:
transmit the billing parameter information with the domain name system packet.

13. An apparatus of claim 8, further comprising:
determine subscription status information associated with the device, a user of the device, or a combination thereof,
wherein the initiating of the query for the billing entity, the transmitting of the identification information to the service provider, or a combination thereof is based on the subscription status information.

14. An apparatus of claim 8, wherein the identification information includes a media access control (MAC) address.

15. A system comprising:
a device configured to generate a request to initiate a web session, wherein the request specifies a web address;
a billing entry associated with the web address, the web session, or a combination thereof; and
a platform configured to receive the request from the device, to initiate a query for the billing entity; and to transmit identification information of the billing entity to a service provider associated with the device.

16. A system of claim 15, wherein the platform is further configured to:
identify packet data exchanged between the device and a web provider associated with web address, the web session, or a combination thereof during the web session; and
reroute or suspend a charge, an invoice, or a combination thereof for at least a portion of the packet data to the billing entity based on the billing entity, the identification information, or a combination thereof.

17. A system of claim 15, wherein the platform is further configured to:
create a billing domain system query for storing an association between the billing entity and the web address, the web session, or a combination thereof; and
transmit the query to a billing domain system for processing.

18. A system of claim 15, wherein the platform is further configured to:
transmit the identification information of the billing entity with a domain name system packet associated with the web address, the web session, or a combination thereof.

19. A system of claim 15, wherein the query includes querying for billing parameter information associated with the billing entity, the web address, the web session, or a combination thereof, wherein the platform is further configured to:
transmit the billing parameter information with the domain name system packet.

20. A system of claim 15, wherein the platform is further configured to:
determine subscription status information associated with the device, a user of the device, or a combination thereof,
wherein the initiating of the query for the billing entity, the transmitting of the identification information to the service provider, or a combination thereof is based on the subscription status information.
